(19) United States
(12) Patent Application Publication
(10) Pub. No.: US 2011/0140331 A1
(43) Pub. Date: Jun. 16, 2011

(54) Device to facilitate fast easy installation of electrical device boxes

(76) Inventor: Mike T. Masiongale, Yorktown, IN (US)

(21) Appl. No.: 12/653,381

(22) Filed: Dec. 14, 2009

(51) Int. Cl. B23Q 1/28

(52) U.S. Cl. 269/74

(57) ABSTRACT

Herein is described an electrical device box installation jig that comprises a rigid sliding scale, one or more fixtures, one or more clamp knobs and a device box holder. The fixture is attached to the device box and is affixed to the sliding scale such that the fixture can slide up and down the scale while holding the device box. The clamp knob holds the fixture in place at the desired height. The device box holder attaches to the device box and holds it in place until the box is secured to a stud.

### BRIEF DESCRIPTION OF THE DRAWINGS

FIG. 1 depicts a perspective drawing of an exemplary embodiment of the electrical box installation jig.

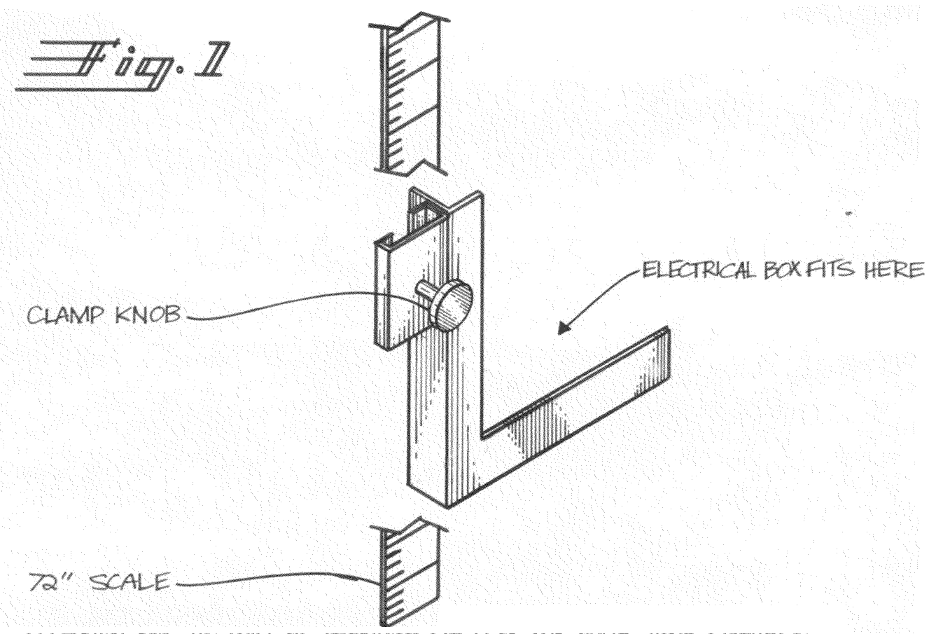

FIG. 2 depicts various views of an exemplary embodiment of the installer.

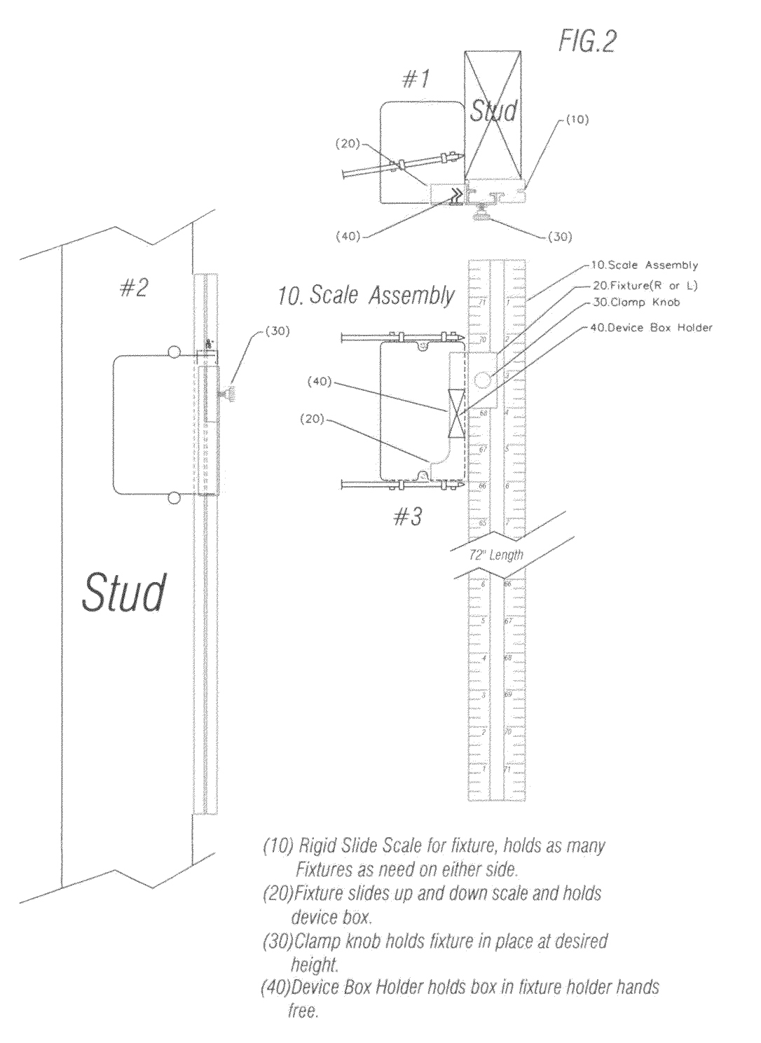

FIG. 3 depicts measurements of an exemplary embodiment of the installer.

### REFERENCE NUMERAL DESCRIPTIONS

(10) is the sliding measuring scale assembly.
(20) is the fixture that is attached to the sliding measuring scale
(30) is the clamp knob holding the fixture secure to the sliding measuring scale
(40) is the device box holder that holds the device box to the to the fixture in a hands free manner.

### DETAILED DESCRIPTION

Herein is described an electrical box installation jig (installer) (referred to as an “Easy Box Installer”) designed to set electrical device boxes at desired heights and at a variety of depths automatically without the use of measuring tapes and marking devices. The Easy Box Installer will eliminate most human errors. In the traditional way of setting up a device one must first measure up from floor or down from ceiling. After marking one must hold the box in place, get a hammer, guess at depth, and secure the box via nails. Over 30% of the device boxes are set too deep in the wall, per code, or out too far.

The Easy Box Installer also eliminates drywallers' errors when cutting out drywall for devices. Most drywallers cut out drywall around device boxes too big, leaving no spot for devices. The Easy Box Installer sets depths of device boxes flush with the face of the drywall, such that the device is supported by the device box instead of depending on the drywall for support. This secure support translates to well-supported electrical devices.

The strap of the electrical device screws tightly to the device box, leaving the electrical device supported by the device box. The Easy Box Installer also cuts down on punch list items and gives customers a better quality job. The Easy Box Installer speeds up installation of device boxes threefold and also reduces installation time for devices. This proper installation eliminates the necessity for compensation strategies such as longer screws or backing up devices with nuts or wire.

The installer is a jig that comprises a rigid sliding scale (10), one or more fixtures (20), one or more clamp knobs (30) and a device box holder (40). The fixture (20) is attached to the sliding scale (10) such that the fixture (20) can slide up and down the scale (10) while holding the device box. The clamp knob (30) holds the fixture (20) in place at the desired height. The device box holder (40) attaches to the fixture (20) and holds the device box in the fixture (20) (in a hands free manner) until the box is secured to a stud.

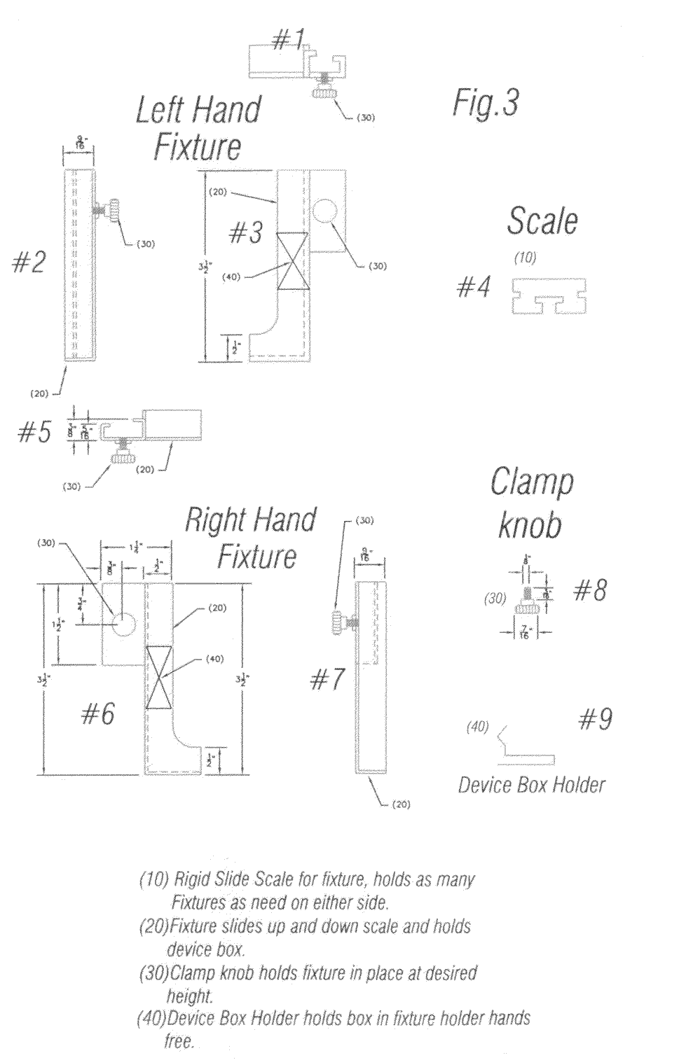

It should be further noted that the installer jig may be made for either left hand or right hand fixtures (see FIG. 3).

What is claimed is:

1. An electrical device box installation jig for installing the box on a stud comprising:
a rigid sliding scale;
one or more fixtures;
one or more clamp knobs; and
a device box holder;
wherein the fixture is attached to the device box and is affixed to the scale such that the fixture can slide up and down the scale while holding the device box, the clamp knob holds the fixture in place at a desired height, the device box holder attaches to the electrical device box and holds it in place until the box is secured to a stud.
